(19) United States
(12) Patent Application Publication
(10) Pub. No.: US 2013/0015370 A1
(43) Pub. Date: Jan. 17, 2013

(54) CONFOCAL FLUORESCENCE SLIDE SCANNER WITH PARALLEL DETECTION

(71) Applicants: Savvas Damaskinos, Kitchener (CA); Arthur Edward Dixon, Waterloo (CA)

(72) Inventors: Savvas Damaskinos, Kitchener (CA); Arthur Edward Dixon, Waterloo (CA)

(73) Assignee: Huron Technologies International In

(21) Appl. No.: 13/550,291

(22) Filed: Jul. 16, 2012

Related U.S. Application Data
(60) Provisional application No. 61/508,423, filed on Jul. 15, 2011.

(51) Int. Cl. G01N 21/64

(52) U.S. Cl. 250/459.1; 250/458.1; 250/200

(57) ABSTRACT

An instrument and method for scanning a large specimen supported on a specimen holder has a plurality of illumination sources with each illumination, source being focused on a different focus spot of the specimen simultaneously. There are a plurality of spectrally resolved detectors to receive light reflected or emitted from the different focus spots simultaneously with each spectrally resolved detector receiving light from one illumination source only.

### BACKGROUND OF THE INVENTION

1. Field of the Invention

This invention relates to the fields of confocal and non-confocal imaging of large microscope specimens with particular emphasis on scanning beam fluorescence and photoluminescence imaging systems, including multi-photon fluorescence, spectrally-resolved fluorescence, and second and third harmonic imaging. Applications include imaging tissue specimens, genetic microarrays, protein arrays, tissue arrays, cells and cell populations, biochips, arrays of biomolecules, detection of nanoparticles, photoluminescence imaging of semiconductor materials and devices, and many others.

2. Description of the Prior Art

FIG. 1 shows one embodiment of a prior art confocal scanning laser macroscope, as described in U.S. Pat. No. 5,760,951. In this embodiment, the incoming collimated laser beam 102 from laser 100 passes through a beam expander (comprised of lens 104 and lens 106), and is expanded to match the diameter of entrance pupil 112 of laser scan lens 114 (note—entrance pupil 112 as indicated on Figure simply indicates the position of the entrance pupil. A real stop is not placed at this position). Scanning mirror 110 deflects the beam in the X direction. Laser scan lens 114 focuses the beam to spot 116 on specimen 118, mounted on microscope slide 120, and light reflected from or emitted by the specimen is collected by laser scan lens 114, descanned by scanning mirror 110, and partially reflected by beamsplitter 108 into a confocal detection arm comprised of laser rejection filter 130, lens 132, pinhole 134, and detector 136. Detector 136 is located behind pinhole 134. Light reflected back from focused spot 116 on specimen 118 further passes through pinhole 134 and is detected, but light from any other point in the specimen runs into the edges of the pinhole and is not detected. The scan mirror is computer-controlled to raster the focused spot across the specimen. At the same time, microscope slide 120, which is mounted on a computer-controlled, motor-driven scanning stage 122, moves slowly in the Y direction. The combination of rapid beam scanning across the specimen while it is moved slowly in the perpendicular Y direction results in a raster-scan motion of focused-laser spot 116 across specimen 118. A computer, represented by computer screen 140, is connected to detector 136 to store and display a signal from detector 136. The computer provides means for acquiring, manipulating, displaying and storing the signal from the detector. This confocal macroscope has properties similar to those of a confocal scanning laser microscope, except that the field of view of the microscope is much smaller.

FIG. 2 shows a further embodiment of a prior art confocal scanning laser macroscope for simultaneous imaging of two different fluorophores. This instrument uses a two-laser or Other two-wavelength source of collimated light with the source wavelengths chosen to match the excitation wavelengths of the two fluorophores. If more than two fluorophores are present, additional laser wavelengths and detection arms can be added, or a spectrally-resolved detector can be used in a single detection arm. When imaging fluorescent, nanoparticles, a single laser source can he used with multiple detection arms, or with a spectrally-resolved detector. A collimated light beam 102 from two-wavelength source 200 is expanded by a beam expander comprised of lens 104 and lens 106, and passes through dichroic filters 208 and 210 on its way to scanning mirror 110. The scan proceeds as described for the macroscope in FIG. 1. Here, light emitted from both fluorophores travels back toward the two defection arms, with light from one fluorophore reflected by dichroic filter 210 into the second detection arm, comprised of laser rejection filter 230, focusing lens 232, pinhole 234 (placed at the focal point of focusing lens 232 in this infinity-corrected system) and is detected by detector 236. Light from the other fluorophore passes through dichroic mirror 210 and is reflected by dichroic mirror 208 into the first detection arm comprised of laser rejection filter 130, focusing lens 132, pinhole 134 and detector 136. Each detector sends an electrical signal proportional to the intensity of the light detected to an A/D converter (not shown) where the intensity of light detected at each pixel position for each fluorophore is converted to a digital value that is stored in an image file, Although many other detectors can be used, we usually use detectors that are comprised of a photomultlplier tube and a preamplifier.

This instrument has several advantages when imaging multiple fluorophores. It has the ability to separately adjust the gain of each detector depending on the fluorescence intensity of that fluorophore, and a high-speed preview scan can be used to predict the gain required for each fluorophore before scanning the final high-resolution image (see PCT application WO 2009/137935 A1). In addition, because the laser scan lens has a wide field of view, large specimens can be scanned in a few wide strips, making it possible to scan very large specimens (up to 6×8 inches in size in one version of a commercial instrument).

Several other technologies are used for fluorescence imaging of large specimens. With tiling microscopes, the image of a small area of the specimen is recorded With a digital camera (usually a CCD camera), the specimen is moved with a computer-controlled microscope stage to image an adjacent area, an image of the adjacent area is recorded, the stage is moved again to the next area, and so on until a number of image flies have been recorded that together cover the whole area of the specimen. Images of each area (image tiles) are recorded when the stage is stationary, after waiting long enough for vibrations from the moving stage to dissipate, and using an exposure time that is sufficient to record the fluorescence images. These image tiles can be butted together, or overlapped and stitched using computer stitching algorithms, to form one image of the entire specimen.

When tiling microscopes are used for fluorescence imaging, the areas surrounding each tile and the overlapping edges of adjacent flies are exposed twice (and the corners four times) which can bleach some fluorophores. Exposure is adjusted by changing the exposure time for each tile. If multiple fluorophores, are imaged, a different exposure time is required for each, so each fluorophore requires a separate image at each tile position. Multiple exposure of the specimen for imaging multiple fluorophores can also increase bleaching of the fluorophores.

A prior art strip-scanning microscope for fluorescence imaging is shown in FIG. 3. A tissue specimen 302 (or other specimen to be imaged) mounted on microscope slide 301 is illuminated from above by illumination source 303. In fluorescence imaging the illumination source is usually mounted above the specimen (epifluorescence) so that the intense illumination light that passes through the specimen is not mixed with the weaker fluorescence emission from the specimen, as it would be if the illumination source were below the specimen. Several different optical combinations can be used for epifluorescence illumination—including illumination light that is injected into the microscope tube between the microscope objective and the tube lens, using a dichroic beamsplitter to reflect it down through the microscope objective and onto the specimen. A narrow wavelength band for the illumination light is chosen to match the absorption peak of the fluorophore in use. Fluorescence emitted by the specimen is collected by infinity-corrected microscope objective 315 which is focused an the specimen by piezo positioner 320. Emission filter 325 is chosen to reject light at the illumination wavelength and to pass the emission band of the fluorophore in use. The microscope objective 315 and tube lens 330 form a real image of the specimen on TDI detector array 340. An image of the specimen is collected by moving the microscope slide at constant speed using motorized stage 300 in a direction perpendicular to the long dimension of the detector array 340, combining a sequence of equally-spaced, time-integrated line images from the array to construct an image of one strip across the specimen. Strips are then assembled to form a complete image of the specimen. When a CCD-based TDI array is used, each line image stored in memory is the result of integrating the charge generated in all of the previous lines of the array while the scan proceeds, and thus has both increased signal/noise and amplitude (due to increased exposure time) when compared to the result from a linear array detector. Exposure can be increased by reducing scan speed, so the scan time (and thus image acquisition time) is increased when using weak fluorophores. It is difficult to predict the best exposure time before scanning. When multiple fluorophores are used on the same specimen, the usual imaging method is to choose illumination wavelengths to match one fluorophore, select the appropriate emission filter and scan time (speed) for the chosen fluorophore, and scan one strip in the image. Then the illumination wavelength band is adjusted to match the absorption band of the second fluorophore, a matching emission filter and scan speed are chosen, and that strip is scanned again. Additional fluorophores require the same steps to be repeated. Finally, this sequence is repeated for all strips in the final image. Some instruments use multiple TDI detector arrays to expose and scan multiple fluorophores simultaneously, but this usually results in a final image where one fluorophore is exposed correctly and the others are either under- or over-exposed. Exposure can be adjusted by changing the relative intensity of the excitation illumination for each fluorophore, which should be easy to do if LED illumination is used. When multiple illumination bands are used at the same time, the resulting image for each fluorophore may differ from that produced when only one illumination band is used, at a time because of overlap of the multiple fluorophore excitation and emission bands, and because autofluorescence from the tissue itself may be excited by one of the illumination bands. Autofluorescence emission usually covers a wide spectrum and may cause a bright background in all of the images when multiple fluorophores are illuminated and imaged simultaneously.

A description of strip scanning instruments, using either linear arrays or TDI arrays, is given in US Patent Application Publication # US2009/0141126 A1 (“Fully Automatic Rapid Microscope Slide Scanner”, by Dirk Soenksen).

When used for fluorescence imaging of a specimen containing only one exogenous fluorophore, a light source with a narrow band of wavelengths (for example, a laser, or a broadband source with a narrow-band transmission filter) is chosen to provide a narrow band of wavelengths near the excitation peak of the fluorophore for illumination of the specimen. A fluorescence emission filter is used to reject wavelengths from the excitation source, and the fluorescence measured by the detector comes from the fluorophore, unless the specimen autofluoresces under that illumination wavelength band, when the signal from the fluorophore is mixed with ah autofluorescence signal. Since autofluorescence is usually broadband emission, much of the autofluorescence can be removed using an emission filter that transmits only a narrow band near the peak of the emission spectrum of the fluorophore.

When fluorescence from a specimen containing multiple exogenous fluorophores is excited by a single illumination source (a light source with a narrow band of wavelengths (for example, a laser) or a broadband source filtered to provide a narrow band of wavelengths near the peak of the excitation spectrum of one of the fluorophores (the first fluorophore), and an appropriate emission filter is used in the detection arm to reject the excitation light, the fluorescence measured by the detector comes entirely from that fluorophore, unless the specimen autofluoresces under that excitation wavelength, or a second fluorophore is weakly excited. This results in fluorescence emission that is a combination of light from the first fluorophore and that from the weakly-excited second fluorophore and from autofluorescence. Since autofluorescence in tissues is strongly excited by illumination in the blue and ultraviolet region of the spectrum, the autofluorescence signal is reduced when a fluorophore that is excited by green or red is illuminated. It is often possible to separate the signal from the first fluorophore from that from the second fluorophore and from autofluorescence using an emission filter set that rejects most of the autofluorescence and the weak fluorescence from the second fluorophore. When fluorescence emission comes from only one focused spot on the specimen (as in a confocal scanning laser microscope) and spectrally-resolved detection is used, it is possible to unmix the signals when the spectrum of each is known. If more than one fluorophore is excited by the same lamination source (for example, when quantum dots are used), it is often possible to separate the signals from each fluorophore using separate detectors and narrow bandpass filters that pass only a range of wavelengths near the emission peak of each fluorophore. Since autofluorescence in tissues is strongly excited by illumination in the blue and ultraviolet region of the spectrum, autofluorescence will be reduced when using red or green illumination.

When multiple illumination sources (for example, lasers) are used simultaneously, or a broadband source filtered to provide multiple excitation bands with different wavelengths is used to illuminate multiple fluorophores, the fluorescence emission from the illuminated focused spot (or area under illumination, in the case of widefield illumination) is a combination of fluorescence from each of the fluorophores (all of which are strongly excited) and autofluorescence, if it exists. Since autofluorescence in tissue is strongly excited by blue and ultraviolet wavelengths, autofluorescence is usually strongly excited when multiple illumination sources are used simultaneously. The emission spectra of common fluorophores usually overlap, and emission filters are chosen to reduce this overlap as much as possible, but the final result is often a mixture that is very difficult to interpret.

Because of the difficulty of unmixing and interpreting data when multiple illumination sources are used to image specimens containing multiple fluorophores, the poor art scanners Image specimens containing multiple fluorophores by sequential scanning, changing the illumination wavelength and -excitation and emission filters before each scan. This also allows additional exposure time to be used for weak fluorophores, since many scanners increase exposure by reducing scan speed. Sequential scanning is a time-consuming operation, and after the sequence of scans is completed, collocation of fluorophores is accomplished by registering the final images from each scan. This registration may be complicated by changes in focus positions and scan speed between the sequential scans.

### DEFINITIONS

For the purposes of this patent document, a “macroscopic specimen” (or “large microscope specimen”) is defined as one that is larger than the field of view of a compound optical microscope containing a microscope objective that has the same Numerical Aperture (NA) as that of the scanner described in this document.

For the purposes of this patent document, “fluorescence” includes single-photon excitation, two-photon and multiphoton fluorescence, spectrally-resolved fluorescence, photoluminescence, and Raman imaging; and “specimen” includes but is not limited to tissue specimens, genetic microarrays, protein arrays, tissue arrays, cells and cell populations, biochips, arrays of biomolecules, plant and animal material, insects and semiconductor materials and devices. Specimens may be mounted on or contained in any kind of specimen holder “Fluorophores” include synthetic fluorophores, fluorescent proteins, and quantum dots. “Autofluorescence” is fluorescence from endogenous molecules, like proteins in a tissue specimen.

A “multispectral” image is one that contains data from several discrete and narrow detection bands. For example, when multiple fluorophores are imaged, the signal from each fluorophore is detected using a narrow-band detection filter. When these images are combined into a single image, it is a “multispectral” image. (No spectra are recorded, only data from a few narrow and discrete detection bands.)

When a spectrally-resolved detector is used to record the spectrum of fluorescence emission from a spot on a specimen, and the data from each spot on the specimen (each pixel position) are combined into an image, such an image is a “hyperspectral” image, and each image pixel is comprised of a fluorescence spectrum measured at that position on the specimen.

The “scan plane” is a plane perpendicular to live optical axis of the instrument in which the specimen is moved by the moving specimen stage. When the specimen is mounted on a microscope slide, the scan plane is usually parallel to the surface of the microscope slide.

A “scan lens” is a colour-corrected and infinity-corrected lens with an external entrance pupil. A mirror scanner can be placed at the external entrance pupil position without requiring any intermediate optics between the mirror scanner and the scan lens. A “laser scan lens” is s scan lens designed for use with laser light sources, and is usually not colour-corrected.

### OBJECTS OF THE INVENTION

1. It is an object of this invention to provide a method and instrument for scanning a large microscope specimen on a glass microscope slide (or other specimen holder) using multiple excitation wavelengths with light of each wavelength focused on a different spot on the specimen, with a separate detector for light emitted from each focused spot, such that multiple fluorophores can be detected simultaneously with little or no crosstalk between fluorophores
2. It is an object of this invention to provide a method and instrument for scanning a large microscope specimen on a glass microscope slide (or other specimen holder) using multiple excitation wavelengths with each wavelength focused on: a different spot on the specimen, and using a separate spectrally-resolved detector for fluorescence emitted from each focused spot, such that emission spectra of multiple fluorophores can be detected simultaneously.
3. It is an object of this invention to provide a method and instrument for scanning a large microscope specimen on a glass microscope slide (or other specimen holder) using multiple excitation sources in a One such that multiple spots on the specimen are exposed at each position of the scanning mirror, and a separate detector for light emitted from each focused spot. This increases the scan speed of the instrument by a factor equal to the number of source/detector pairs by reducing the number of separate scans that otherwise would have been necessary to collect an image of the specimen from each excitation source.
4. If is an object of this invention to provide a method and instrument for scanning a large microscope specimen on a glass microscope slide (or other specimen holder) using multiple excitation sources in a line (each excitation source having the same wavelength, or narrow band of wavelengths) and a spectrally-resolved detector for light from each focused spot on the specimen such that the speed of a spectrally-resolved instrument is multiplied by the number of parallel source/detector combinations. This combination is particularly useful for spectrally-resolved fluorescence or spectrally-resolved multiphoton fluorescence, photoluminescence (for example from semiconductor specimens), and Raman imaging.
5. The multiple excitation source used in Objects 1-4 can be comprised of a line of lasers or LED's, or a line of pinholes illuminated from behind.
6. The multiple detectors used in objects 1-4 can be a line of detectors spaced to receive light only from each separate source, or a linear array to receive light from the line of sources where one pixel (or small number of pixels) that receives light front each source, but not light from other sources, can be chosen to make up the source/detector pairs.
7. A spectrometer containing a 2D detector array can be used with a line of excitation sources to provide spectrally-resolved detection of each excitation source, with the spectrum from each excitation source detected by a different line of pixels on the 2D detector array.
8. For quantum dots (which can all he excited by the same excitation wavelength), multiple identical illumination sources can he used in a line, and the spectrum from each illuminated spot on the specimen can be detected using a spectrometer with multiple detectors (or multiple spectrally-resolved detectors), resulting in an increase in the scan speed of the instrument by a factor of the number of illumination sources.

### SUMMARY OF INVENTION

An instrument for scanning a large specimen comprises a plurality of illumination sources and at least one lens to focus light from each illumination source on a different focus spot of the specimen simultaneously. There are a plurality of focus spots, with each illumination source being focused on a different focus spot of the plurality of focus spots. There are a plurality of spectrally resolved detectors to receive fluorescence emitted from the different focus spots simultaneously. The detectors are isolated from one another so that substantially all of the fluorescence emitted from each focus spot is received by a different detector of the plurality of detectors.

A method of using an instrument for scanning a large specimen on a specimen holder has a plurality of illumination sources and at least one lens to focus light from each illumination source on a different focus spot of the specimen. The instrument has one detector for each focus spot of the specimen that is to be detected and there are a plurality of focus spots. The method comprises activating the instrument including the plurality of illumination sources, adjusting the at least one lens to focus the light from each illumination source onto different focus spots of the specimen, each focus spot receiving light from only one illumination source, choosing and arranging spectrally resolved detectors to receive fluorescence emitted or reflected light from the different focus spots simultaneously and isolating the detectors from one another so that each detector receives light substantially from one illumination source only.

A method of using an instrument for scanning a large specimen has a plurality of illumination sources and at least one lens to focus light from each illumination source onto a different focus spot of the specimen, The instrument has one detector for each focus spot of the specimen that is to be detected and there are a plurality of focus spots. The method comprises activating the instrument including the plurality of illumination sources, adjusting the at least one lens to focus light from each illumination source onto different focus spots of the specimen, each focus spot receiving light from only one illumination source, minimizing cross talk between the detectors by ensuring that the different focus spots on which the light from the illumination source is focused are separated by distances of at least approximately ten spot diameters from each other, arranging the detectors to receive emitted or reflected light from the different focus spots simultaneously and isolating the detectors from one another so that each detector receives light substantially from one illumination source only.

A method of using an instrument for scanning a large specimen has a plurality of illumination sources and at least one tens to focus light from each illumination source onto a different focus spot of the specimen. The instrument has one detector for each focus spot of the specimen that is to be detected there being a plurality of focus spots and a plurality of detectors. The method comprises positioning the illumination sources in an XY plane such that the focus spots to be detected are along a line in the Y direction and scanning spots move across the specimen in the X direction so that the focus spots to be detected are located a distance apart from one another to avoid any long lifetime fluorophores that are excited by first focus spot and are detected by a second detector mixed with a fluorescence signal excited by a second illumination source, there being at least two focus spots, at least two detectors and at least two illumination sources.

A method of using an instrument for scanning a large specimen comprises predicting an exposure required for each fluorophore using a high-speed preview scan and using the information from the previous scan to adjust the gain of each of the detectors for simultaneous detection of weak and strong fluorophores and the ability to scan very large specimens.

An instrument for scanning a large specimen comprises a plurality of illumination sources and at least one lens to focus light from each illumination source onto a different focus spot of the specimen, the instrument having one detector for each focus spot of the specimen that is to be detected, there being a plurality of focus spots, each focus spot receiving light from only one illumination source, cross talk between the plurality of detectors being minimized by ensuring that the focus spots to be defected are at least approximately ten spot diameters from each other, the detectors being arranged to receive emitted or reflected light from the different focus spots simultaneously and being isolated from one another so that each detector receives light substantially from one illumination source only.

An instrument for scanning a large specimen having components arranged to carry out the methods of using the instrument.

### BRIEF DESCRIPTION OF THE DRAWINGS

FIG. 1 is a schematic view of a prior art confocal scanning-beam/scanning-stage optical macroscope;

FIG. 2 is a schematic view of a prior art confocal scanning-beam/scanning-stage macroscope for simultaneous imaging of two fluorophores;

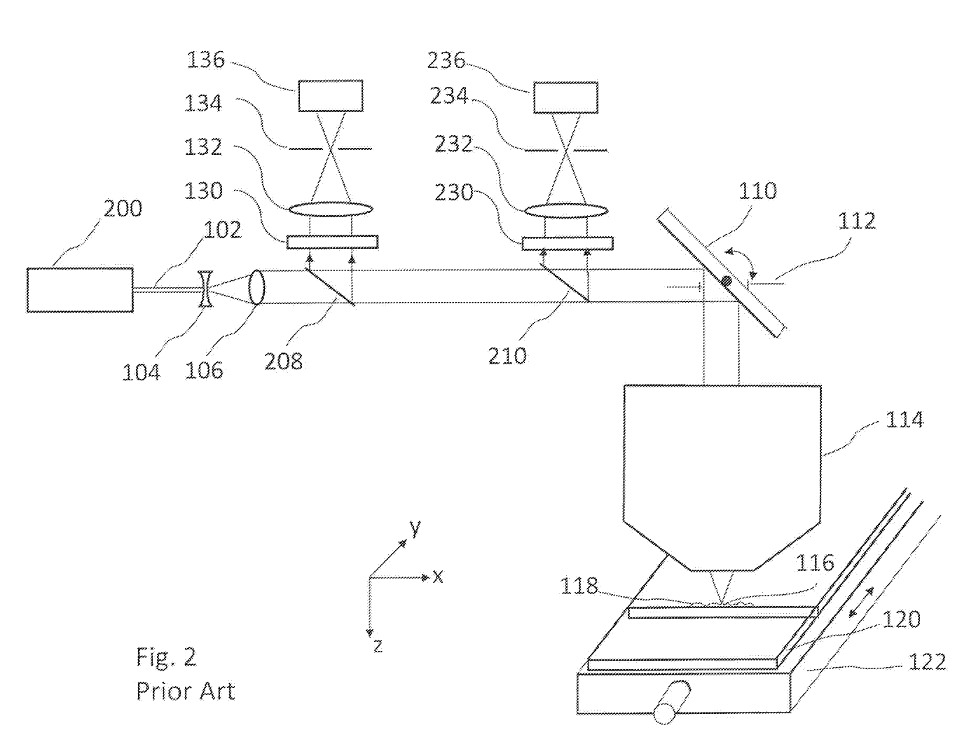

FIG. 3 shows a prior art strip-scanning microscope for fluorescence imaging;

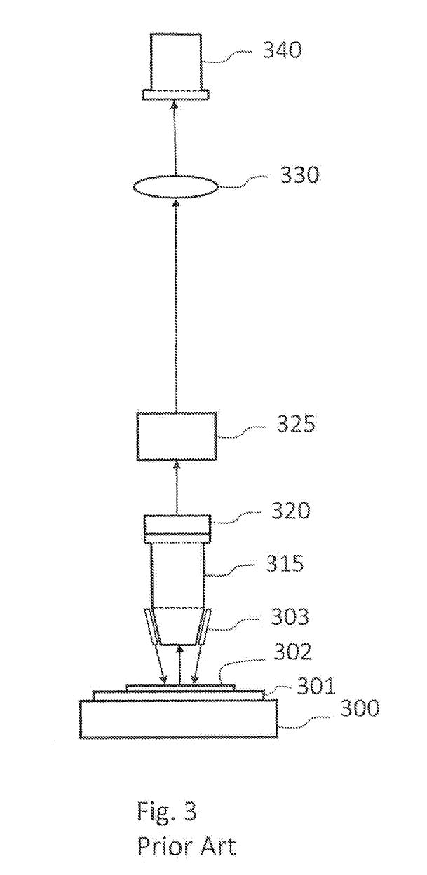

FIG. 4 shows a confocal scanning-beam/scanning-stage optical macroscope with two illumination/detection arms;

FIG. 5 shows a confocal scanning-beam/scanning-stage optical macroscope with two discrete illumination sources in the illumination arm and two separate detection arms;

FIG. 6 shows a confocal scanning-beam/scanning-stage optical macroscope with two discrete illumination sources in the illumination arm and two discrete detectors in a single detection arm;

FIG. 7 shows a large specimen on a microscope slide that will be imaged in several strips;

FIG. 8 shows overlapping images of one strip of the specimen in FIG. 7 as acquired by three separate detectors;

FIG. 9 shows a confocal scanning-beam/scanning-stage optical macroscope with a linear array of discrete illumination sources in the illumination arm and a linear array of discrete detectors in a single detection arm;

FIG. 10 shows a single image strip acquired by an instrument containing five light sources with the same wavelength and five detectors; and

FIG. 11 shows pixels being collected by two detectors (of the five) in the instrument referred to in FIG. 10.

### DESCRIPTION OF THE INVENTION

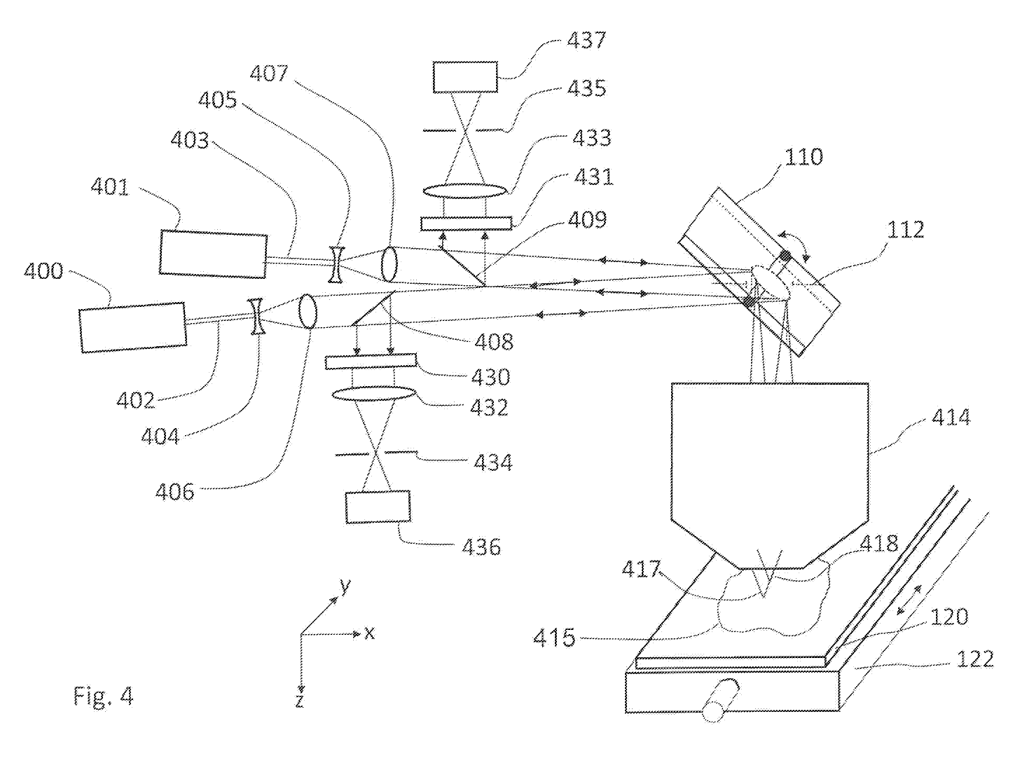

FIG. 4 shows a confocal scanning-beam/scanning-stage optical macroscope with two illumination/defection arms that is a first embodiment of this invention.

In this embodiment, a first incoming collimated laser beam 402 from laser 400 passes through a beam expander (comprised of lens 404 and lens 406), and is expanded to match the diameter of entrance pupil 112 of scan lens 414 (note—entrance pupil 112 as indicated on Figure simply indicates the position of the entrance pupil of scan lens 414. A real stop is not placed at this position). Scanning mirror 110 deflects the beam to move the scanning spot in the X direction. Scan lens 414 focuses the beam to spot 418 on specimen 415, mounted on microscope slide 120, and light reflected from or emitted by the specimen is collected by scan lens 414, descanned by scanning mirror 110, and partially reflected by beamsplitter 408 into a first confocal detection arm comprised of laser rejection filter 430, lens 432, pinhole 434, and detector 436. Detector 436 is located behind pinhole 434. Light reflected (or emitted) from focused spot 418 on specimen 415 passes through pinhole 434 and is detected, but light from any other point in the specimen runs into the edges of the pinhole and is not detected. Detector 436 detects light emitted from focus spot 418 which is illuminated by laser 400. Laser 400 and detector 436 comprise a “light source/detector pair”.

At the same time, a second incoming collimated laser beam 403 from laser 401 passes through a second beam expander (comprised of lens 405 and lens 407), and is expanded to match the diameter of entrance pupil 112 of scan lens 414. Scanning mirror 110 scans the beam, moving the focus spot in the X direction. Scan lens 414 focuses the beam to spot 417 on specimen 415, mounted on microscope slide 120, and light reflected from or emitted by the specimen is collected by scan lens 414, descanned by scanning mirror 110 and partially reflected by beamsplitter 409 into a second confocal detection arm comprised of laser rejection filter 431, lens 433, pinhole 435 and detector 437.

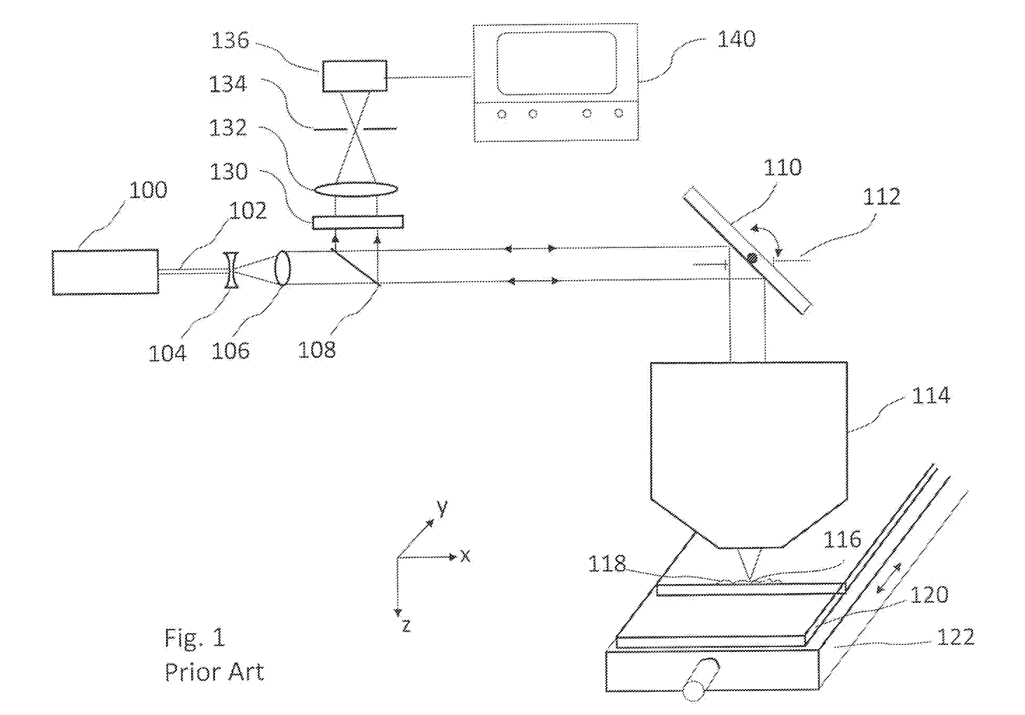

The scan mirror rotates about the Y axis, and is computer-controlled to raster the focused spots across the specimen. At the same time, microscope slide 120, which is mounted on a computer-controlled, motor-driven scanning stage 122, moves slowly in the Y direction. The combination of rapid beam scanning across the specimen in the X direction while the specimen is moved slowly in the perpendicular Y direction results in a raster-scan motion of focused-laser spots 418 and 417 across specimen 415. A computer, represented by computer screen 140 in FIG. 1, is connected to detectors 436 and 437 to acquire, manipulate, store and display signals from detectors 436 and 437. The computer provides means for acquiring, manipulating, displaying and storing image data from the two detectors, and is used in all the embodiments described herein. The two images can be displayed separately, or combined into a single image for collocation of fluorophores. Before combination, one image must be translated a distance in the Y direction equal to the distance between the focused spots 417 and 418. In practice, because of the difficulty of placing the two lasers accurately in the XY plane, the images are usually also displaced a short distance in the X direction, and must be translated to correct for that displacement as well.

In practice, crosstalk between the two parallel source/detector optical paths is minimal if the two focused spots 417 and 418 are separated by a distance of approximately 10 spot diameters or more.

Although this disclosure has described an instrument with two illumination/detection arms, additional illumination/detection arms can be utilized.

Note that lasers 400 and 401 are doth positioned in the XY plane such that focused spots 417 and 418 are along a line in the Y direction, and the scanning spots move across the specimen in the X direction. If lasers 400 and 401 were placed in the XZ plane, then the focused spots 417 and 418 would be along a line in the X direction, so that one would follow close behind the other as they are deflected across the specimen by the scanning mirror. This could present a problem in the case of long lifetime fluorophores, where a decaying fluorescence signal excited by the first focus spot could be detected by the second detector, mixed with the fluorescence signal excited by the second laser.

A major advantage of this invention when scanning multiple fluorophores is that each fluorophore can be excited and defected separately, but detection is simultaneous instead of sequential, reducing the scan time considerably. The advantages of using a single illumination source for each fluorophore have been described earlier in this document. This can be combined with the advantages of the prior-art macroscope described earlier—the ability to predict the exposure required for each fluorophore using a high-speed preview scan, which allows the gain of the separate detectors to be adjusted for simultaneous detection of weak and strong fluorophores, and the ability to scan very large specimens.

The instrument described here is a combination of two instruments sharing the same mirror scanner, scan lens and moving specimen stage, but different light sources that illuminate different focus spots on the specimen, and a separate detection arm for signals emitted from each focused spot. The two instruments can be quite different from each other—combinations could include two (or more) from confocal scanning fluorescence macroscope, spectrally-resolved confocal scanning fluorescence macroscope, confocal scanning reflection macroscope, scanning laser multiphoton fluorescence macroscope or harmonic detection macroscope (using a femtosecond or picosecond pulsed laser source), scanning photoluminescence macroscope, scanning brightfield macroscope (using a white light source and placing a transmission RGB detector below the specimen), scanning Raman macroscope, and others.

This confocal scanning laser macroscope has properties similar to these of a confocal scanning laser microscope, except that the field of view of a microscope is much smaller. The instruments, applications and methods described here also apply to confocal scanning light microscopes and microscopy.

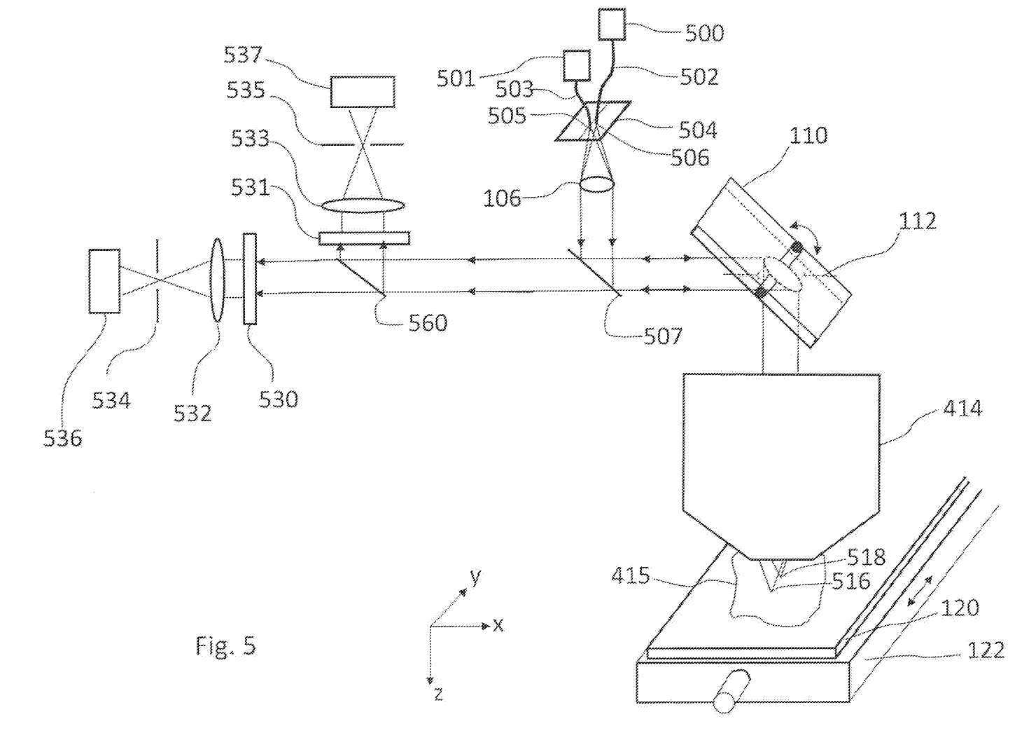

FIG. 5 shows a confocal scanning-beam/scanning-stage optical macroscope with a single illumination arm transmitting light from two separate light sources, and two defection arms, one for light emitted from each focused spot on the specimen that is a second embodiment of this invention. In this embodiment, light from a first light source 500 passes through a small-diameter fiber optic cable 502 attached to holder 504 that holds the end of the fiber at position 506 on the focal plane of lens 106. Light from the fiber expands to fill lens 106, resulting in a parallel beam of light moving toward a beamsplitter 507 that partially reflects the beam towards scanning mirror 110. After reflection from the scanning mirror, the parallel beam is focused by scan lens 414 onto specimen 415 at focus spot 516. Specimen 415 is mounted on microscope slide 120 (or other specimen holder), and light reflected from or emitted by the focus spot 516 on the specimen is collected by scan lens 414, descanned by scanning mirror 110, passes through beamsplitter 507 and is partially reflected by beamsplitter 560 into a first confocal detection arm comprised of fluorescence bandpass filter 531, lens 533, pinhole 535, and detector 537. Beamsplitter 560 is commonly a dichroic beamsplitter that reflects a band of wavelengths near the emission peak of the fluorophore excited by first light source 500, but transmits light that is not in this narrow band of wavelengths. The fluorescence bandpass filter is typically a bandpass filter that passes a band of wavelengths near the emission peak of the fluorophore excited by first light source 500, but rejects other wavelengths. Detector 537 is located behind pinhole 535, which is positioned to transmit light from focus spot 516 but to reject light from the second focus spot 518. Light emitted from focused spot 516 on specimen 415 passes through pinhole 535 and is detected, but light from any other point in the specimen runs into the edges of the pinhole and is not detected.

At the same time, light from a second light source 501 passes through a small-diameter fiber optic cable 503 attached to holder 504 that holds the end of the fiber at position 505 on the focal plane of lens 106. Light from the fiber expands to fill lens 106, resulting in a parallel beam of light that is partially reflected toward the scanning mirror 110 which is focused by scan lens 414 onto specimen 415 at focus spot 518. Specimen 415 is mounted on microscope slide 120 (or other specimen holder), and light reflected from or emitted by the focus spot 518 on the specimen is collected by scan lens 414, descanned by scanning mirror 110, passes through beamsplitters 507 and 560 into a second confocal detection arm comprised of fluorescence bandpass filter 530, lens 532, pinhole 534, and detector 536, Fluorescence bandpass filter 530 passes a band of wavelengths near the emission peak of the flurorophore excited by second light source 501, but rejects other wavelengths. Detector 536 is located behind pinhole 534, which is positioned to transmit light from focus spot 518 but to reject light from the second focus spot 516. Light emitted from focused spot 518 on specimen 415 passes through pinhole 534 and is defected, but light from, any other point in the specimen runs into the edges of the pinhole and is not detected.

The scan mirror rotates about the Y axis, and is computer-controlled to raster the focused spots across the specimen. At the same time, microscope slide 120, which is mounted on a computer-controlled, motor-driven scanning stage 122, moves slowly in the Y direction. The combination of rapid beam scanning across the specimen while the specimen is moved slowly in the perpendicular Y direction results in a raster-scan motion of focused spots 518 and 516 across specimen 415. A computer, represented by computer screen 140 in FIG. 1 is connected to detectors 536 and 537 and provides means for acquiring, manipulating, displaying and storing signals from the two detectors. The two images can be displayed separately, or combined into a single image for collocation of fluorophores. Before combination, one image must be translated a distance in the Y direction equal to the distance between the focused spots 516 and 518. In practice, because of the difficulty of aligning the ends of the two fiber optic cables 502, 503 accurately in the XY plane, the images may also be displaced a short distance in the X direction, and must be translated to correct for that displacement as well.

In practice, crosstalk between the two fluorescence signals is minimal if the two focused spots 516 and 518 are separated by a distance of approximately 10 spot diameters or more.

Although this disclosure has described an instrument with two discrete point light sources in the focal plane of lens 106, and two detection arms, additional point light sources and detection arms can be utilized.

Note that the ends of fiber optic cables 502 and 503 are placed at positions 506 and 505 in the focal plane of lens 106, such that the two fiber optic ends are in a line parallel to the Y axis. This arrangement positions the two focus spots 516 and 518 along a line parallel to the Y axis, so that they do not follow each other closely in time as they would if they were positioned along a line in the X direction. This could present a problem in the case of long lifetime fluorophores, where a decaying fluorescence signal excited by the first laser could be detected by the second detector, mixed with the fluorescence signal excited by the second laser.

Just as with the first embodiment, a major advantage of the second embodiment of this invention when scanning multiple fluorophores is that each fluorophore can be excited and detected separately, but detection is simultaneous instead of sequential, reducing the scan time considerably. This can be combined with the advantages of the prior art macroscope described earlier—the ability to predict the exposure required for each fluorophore using a high-speed preview scan, which allows the gain of the separate detectors to be adjusted for simultaneous defection of weak and strong fluorophores, and the ability to scan very large specimens.

The second embodiment of the present invention is a combination of two instruments sharing the same optical beam path, mirror scanner, scan lens and moving specimen stage, but different sources that illuminate different focus spots on the specimen, and separate detection arms for signals emitted from each focused spot. As before, the two instruments can be quite different from each other—combinations could include two (or more) from: confocal scanning fluorescence macrosoope, spectrally-resolved confocal scanning fluorescence macrosoope (in which one or both of detectors 536 and 537 are spectrally-resolved detectors), confocal scanning reflection macroscope, scanning laser multiphoton fluorescence macroscope or harmonic detection macrosoope (using a femtosecond or picosecond pulsed laser source), scanning photoluminescence macroscope, scanning brightfield macrosoope (using a white light source and placing a transmission RGB detector below the specimen), scanning Raman macrosoope, and others.

This confocal scanning macroscope has properties similar to those of a confocal scanning light microscope, except that the field of view of a microscope is much smaller. The instruments, applications and methods described here also apply to confocal scanning light microscopes and microscopy.

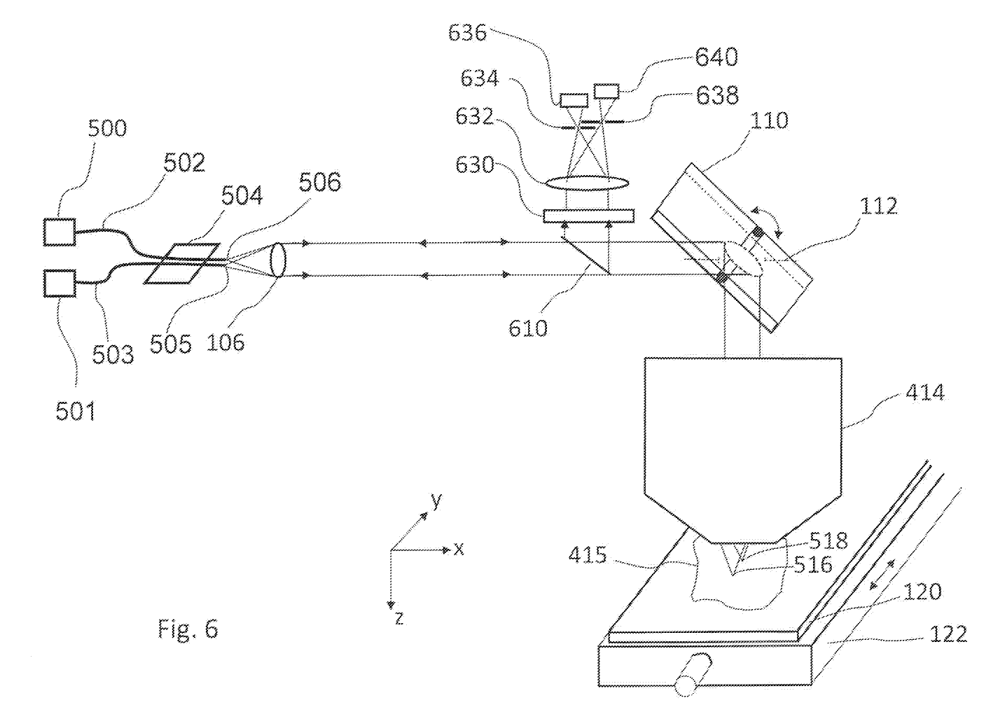

FIG. 6 shows a confocal scanning-beam/scanning-stage optical macroscope with a single illumination arm transmitting light from two separate light sources, and a single detection arm containing two detectors, one for light emitted from each focused spot on the specimen that is a third embodiment of this invention. In this embodiment, light from a first light source 500 passes through a small-diameter fiber optic cable 502 attached to holder 504 that holds the end of the fiber at position 506 on the focal plane of lens 106. Light from the fiber expands to fill lens 106, resulting in a parallel beam of light moving through beamsplitter 610 toward the scanning mirror 110 which is focused by scan lens 414 onto specimen 415 at focus spot 516. Specimen 415 is mounted on microscope slide 120 (or other specimen holder), and light reflected from or emitted by the focus spot 516 on the specimen is collected by scan lens 414, descended by scanning mirror 110, and partially reflected by beamsplitter 610 info a confocal detection arm comprised of filter 630, lens 632, pinholes 638 and 634, and detectors 640 and 636. Beamsplitter 610 is commonly a beamsplitter that reflects most of the light approaching it from either direction (an 80/20 beamsplitter is common), and transmits a small fraction of the light that approaches it from either direction.

In a similar fashion, light from second light source 501 passes through a small-diameter fiber optic cable 503 attached to holder 504 that holds the end of the fiber at position 505 on the focal plane of lens 106. Light from that fiber expands to fill lens 106, resulting in a second parallel beam of light moving through beamsplitter 610 toward the scanning mirror 110 which is focused by scan lens 414 onto specimen 415 at focus spot 518. Light emitted from or reflected from focus spot 518 is collected by scan lens 414, descanned by scanning mirror 110, and partially reflected by beamsplitter 610 into a confocal detection arm composed of filter 630, lens 632, pinholes 638 and 634, and detectors 640 and 636. Light emitted from focused spot 518 on specimen 415 passes through pinhole 634 and is detected by detector 636. Light from any other parts of the specimen (except for focus spots 516 and 518) runs into the edges of the pinholes and is not detected by either detector.

Although this disclosure of the third embodiment of this invention has described an Instrument with two discrete point light sources in the focal plane of lens 106, and a single detection arm containing two detectors, additional point light sources and detectors can be utilized.

Note that the ends of fiber optic cables 502 and 503 are placed at positions 506 and 505 in the focal plane of lens 106, such that the two fiber optic ends are in a line parallel to the Y axis. This results in the two focus spots 516 and 518 being positioned along a line parallel to the Y axis, and the pinholes 634 and 838 are also placed on a line parallel to the Y axis, and positioned to transmit light from focus spots 518 and 516 respectively towards detectors 636 and 640.

If light sources 500 and 501 have different frequencies chosen to match the excitation peak of two different fluorophores, for example), then beamsplitter 610 should be chosen to reflect a broad band of wavelengths that includes the emission bands of both fluorophores (the 80/20 beamsplitter described earlier is one example). Filter 630 should be moved to the space between lens 632 and detector 636 and close to pinhole 634, and chosen to reject the frequency band of light source 501 and pass the emission band of the first fluorophore being excited by light source 501. A second fitter (not shown) should also be placed between lens 632 and detector 640, close to pinhole 638, to reject, the source frequency of light source 500 and to pass the emission spectrum of the second fluorophore being excited by light source 500. As with the first and second embodiment of the present invention, a major advantage of the third embodiment of this invention when scanning multiple fluorophores is that each fluorophore can be excited and detected separately, but detection is simultaneous instead of sequential, reducing the scan time considerably. The advantages of using an illumination source for each fluorophore that is matched to the peak of its excitation spectrum have been described earlier in this document. This can be combined with the advantages of the prior art macroscope described earlier—the ability to predict the exposure required for each fluorophore using a high-speed preview scan, which allows the gain of the separate detectors to be adjusted for simultaneous detection of weak and strong fluorophores, and the ability to scan very large specimens.

If light sources 500 and 501 are identical in frequency and intensity, then beamsplitter 610 can be chosen to transmit the frequency band of the light sources and reflect a band of wavelengths near the emission peak of one fluorophore towards the detection arm (a dichroic beamsplitter is one possible choice) and filter 630 can be chosen to reject the wavelength band of the identical light sources. In this arrangement both focus spots 515 and 518 are illuminated with the same narrow band of excitation wavelengths, and detectors 636 and 640 detect the same band of emission, wavelengths. Each scan of the scanning mirror moves two focus spots across the specimen, and the fluorescence from these spots is detected simultaneously. This instrument works just like the prior art macroscope described in FIG. 1, but is twice as fast, increasing the number of light source/detector pairs will increase the imaging speed of the instrument proportional to the number of light source/detector pairs, while keeping the scan speed of the focus spots constant.

When a spectrally-resolved detector is used in a macroscope, the scan speed must be reduced considerably because the light intensity falling on each detector element in the spectrometer is considerable reduced by spreading the beam entering the detector over a range of wavelengths. Longer exposure times are required, and therefore slower scan speed. This makes the increase of imaging speed of the instrument using multiple light source/detector pairs even more important.

A confocal scanning optical microscope can be constructed by replacing scan lens 414 with an infinity-corrected microscope objective, and adding a unitary telescope between the microscope objective and the scanning mirror, placed to transfer the scanning light beams from the center of the scanning mirror to the center of the entrance pupil of the microscope objective. All of the embodiments shown in this document can be modified in this way to construct a scanning optical microscope.

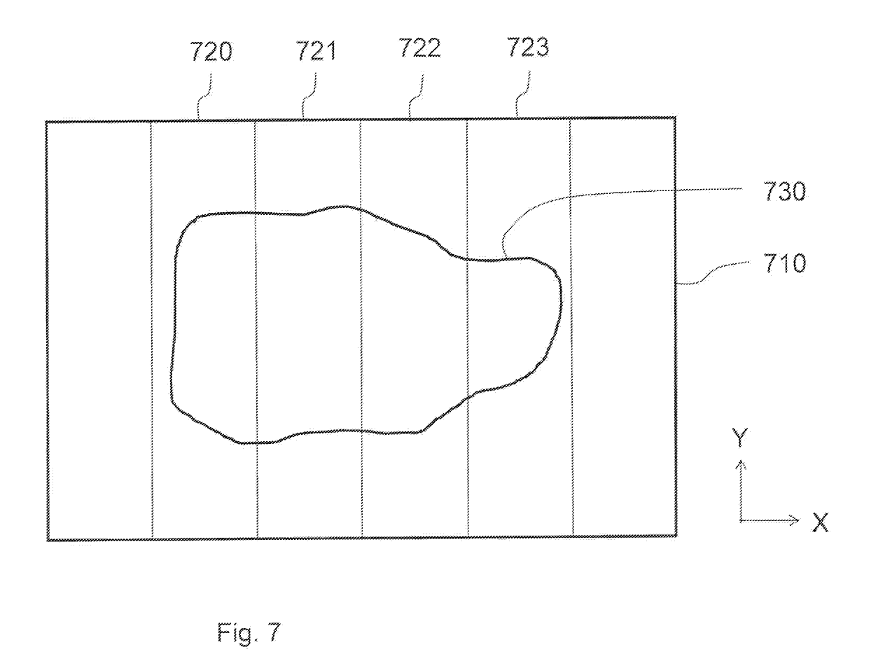

FIG. 7 shows a large specimen 730 on a microscope slide. Specimen 730 is wider than the scan width of the macroscope and must be scanned in four strips (720, 721, 722 and 723) in order to acquire an image of the entire specimen. To illustrate how such a specimen is imaged with multiple fluorophores, suppose the specimen contains three fluorophores, and that an image with one micron pixels is required. Also, suppose that the second embodiment described in FIG. 5 contains three illumination sources in a line (instead of the two sources shown), each chosen to excite one of the three fluorophores in specimen 730. A third defection arm (not shown in FIG. 5) can be added to the instrument by placing a third beamsplitter between beamsplitters 507 and 560, to reflect light near the fluorescence emission peak of the third fluorophore into the third detection arm, while transmitting other wavelengths. The three detection arms are arranged such that each detector detects light emitted from one of the three focused spots on the specimen, and rejects light from the other two. If the three illumination sources are spaced to provide three illuminated spots on the specimen that are approximately 10 microns apart (approximately 10 pixels apart), crosstalk between fluorophores will be minimized.

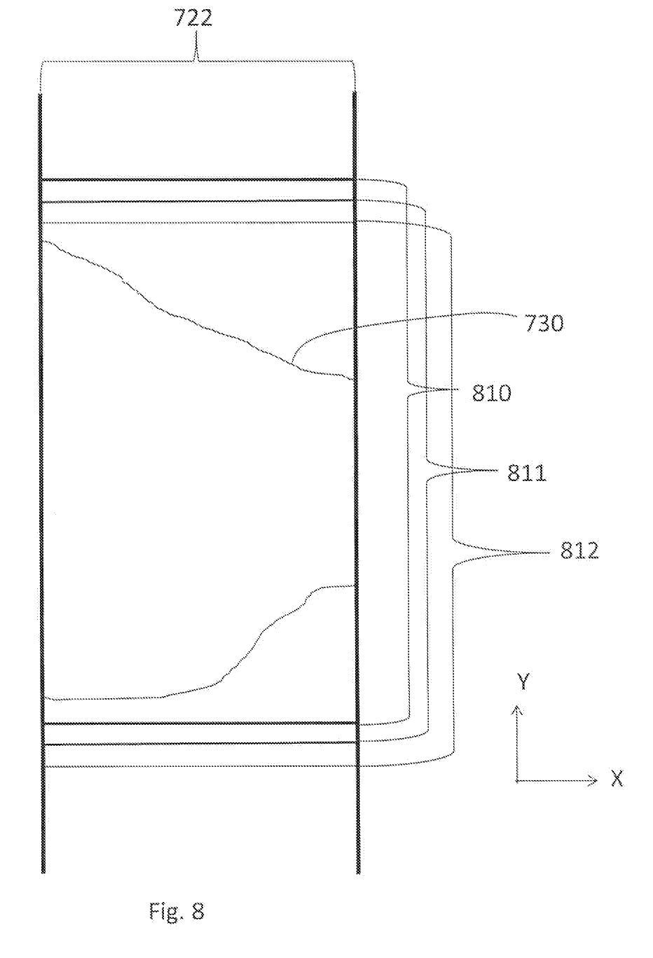

FIG. 8 shows how image data from each fluorophore will be acquired for scan strip 722 in FIG. 7. Only the portion of specimen 730 that will be imaged in scan strip 722 is shown in FIG. 8. If the scanning stage moves the specimen slowly in the +Y direction (the specimen is moving upwards in FIG. 8) and the scanning mirror moves the three focus spots rapidly back and forth from left to right during scan, the first detector captures image 810 at the same time the second detector is capturing image 811 and the third detector collects image 812. When the scan is complete, the image from the first detector is translated 10 microns in the −Y direction, and that from the third detector is translated 10 microns (ten pixels in this example) in the +Y direction to register the three fluorescence images together. After images from the three fluorophores have been registered in each of the four scan strips, the four strips are stitched together to produce a single image of the entire specimen. This may be viewed as three separate fluorescence images, or false colours can be assigned to each fluorophore to generate a single colour image.

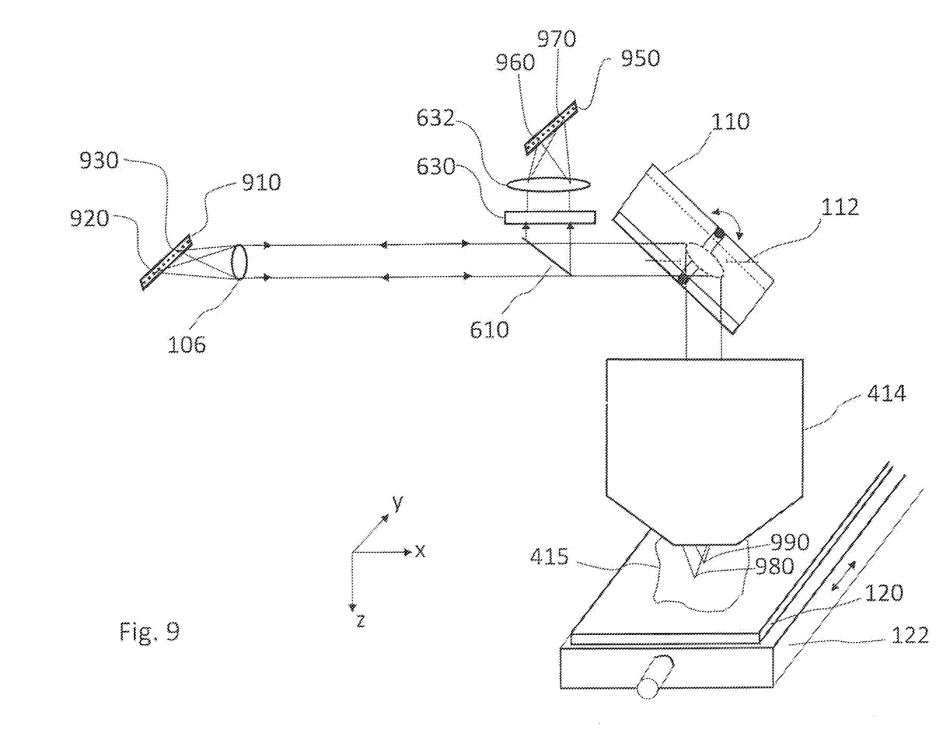

FIG. 9 shows a confocal scanning-beam/scanning-stage optical macroscope with a single illumination arm transmitting light from an array of separate light sources arranged along a line parallel to the Y direction, and a single detection arm containing an array of detectors, also arranged along a line parallel to the Y direction, one detector for light emitted from each focused spot on the specimen that is a fourth embodiment of this invention. In this embodiment, light from a first point light source 920 (one of the point sources in source array 910) expands to fill lens 106, resulting in a parallel beam of light moving through beamsplitter 610 toward the scanning mirror 110 and focused by scan lens 414 onto specimen 415 at focus spot 990. Specimen 415 is mounted on microscope slide 120 (or other specimen holder), and light reflected from or emitted by the focus spot 990 on the specimen is collected by scan lens 414, descanned by scanning mirror 110, and partially reflected by beamsplitter 610 into a confocal detection arm comprised of filter 630, lens 632, and detector array 950. Light reflected or emitted from focus spot 990 is detected by detector 960 in detector array 950, in the same way, light from a second point light source 930 in source array 910 expands to fill lens 106, resulting in a second parallel beam of light moving through beamsplitter 610 toward the scanning mirror 110 which is focused by scan lens 414 onto specimen 415 at focus spot 980. Light emitted by or reflected from focus spot 980 is collected by scan lens 414, descanned by scanning mirror 110, and partially reflected by beamsplitter 610 info a confocal detection arm comprised of filter 630, lens 632, and detector array 950. Light emitted from focused spot 980 on specimen 415 is detected by detector 970 in detector array 950.

Each of the point light sources in source array 910 will illuminate a separate focus point on specimen 415 (only two of these focus points are shown in the diagram), and light reflected by or emitted from each focus point (or spot) will be detected by a detector in detector array 950. The distance between detectors in the array is adjusted to match the positions where light emitted from or reflected by each focused spot on the specimen illuminates the array, and the detectors should be spaced far enough apart so the inactive material between them acts like the solid material surrounding the pinholes described in descriptions of the second and third embodiments. When all of the focus spots are illuminated, light from only one focus spot is defected by each detector in detector array 950, and light from any other point in the specimen is substantially rejected by the inactive material in the area surrounding each detector in the array. For best operation, light sources in the source array should be small enough for lens 106 to produce a light beam from each source that is essentially a parallel beam, and they should be far enough apart so that the focused spots on the specimen are separated by a distance approximately fen times the diameter of each spot.

The array of light sources may be comprised of an array of lasers, an array of light-emitting diodes, an array of pinholes illuminated from behind, or any other array of sources that fulfills the requirements of small size, physical separation and wavelength bandwidth appropriate for the fluorophore in use, and may be either continuous or pulsed sources. Pulsed sources include femtosecond and picosecond pulsed sources for use in multiphoton or harmonic microscopy. The array of detectors used in this embodiment can be a number of detectors in a line, where the number of detectors is equal to the number of light sources, spaced such that each detector receives light from only one focused spot on the specimen; or a linear array of detectors containing many more detectors than there are light sources, where one pixel in the linear array of detectors (or a small number of adjacent pixels) is chosen to act as one detector in each source/detector pair, using pixels spaced appropriately so that each, detector receives light from only one focused spot on the specimen, Data from pixels between the active pixels that comprise the detectors in the source/detector pairs are not recorded or used.

If all of the light sources in detector array 910 are identical in wavelength and intensity, then beamsplitter 610 can be chosen to transmit the wavelength band of the light sources and reflect a band of wavelengths near the emission peak of one fluorophore towards the defection arm (a dichroic beamsplitter is one possible choice) and filter 630 can be chosen to reject the wavelength band of the identical light sources. In this arrangement all of the focus spots are illuminated with the same narrow band of excitation wavelengths, and all detectors in detector array 950 detect the same band of emission wavelengths. Each scan of the scanning mirror moves ail focus spots across the specimen, and the fluorescence from these spots is detected simultaneously. This instrument works just like the prior art macroscope described in FIG. 1. but it is faster by a factor of the number of light source/detector pairs in the instrument. An Instrument with 16 light sources and 16 detectors collects image data 16 times faster than the macroscope described in FIG. 1, using the same exposure time, because it collects 16 lines of image data simultaneously. Keeping the exposure time (called the “dwell time” in a scanning spot instrument) as long as possible is very important for fluorescence imaging, where some fluorophores are very weak. The scan time can be reduced by simply scanning faster, but this reduces the exposure time and often results in noisy images.

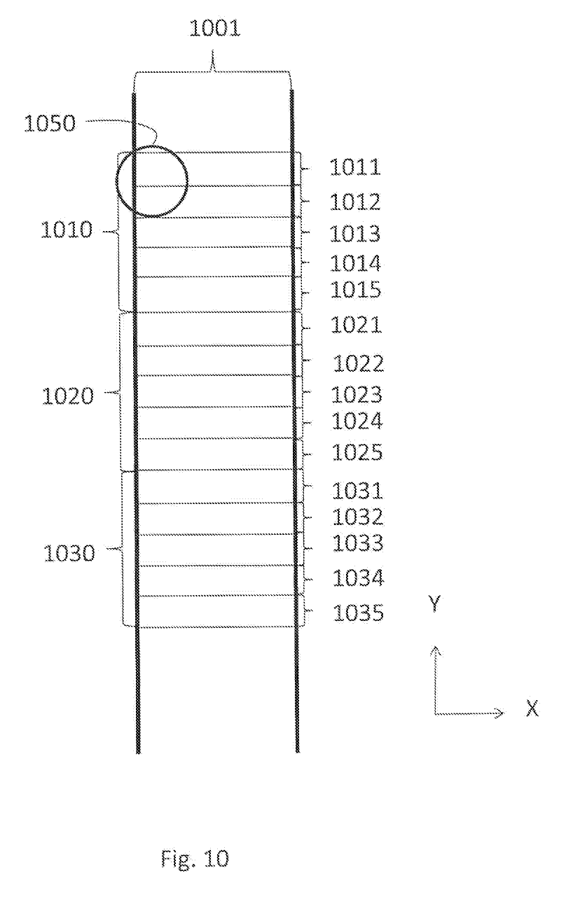

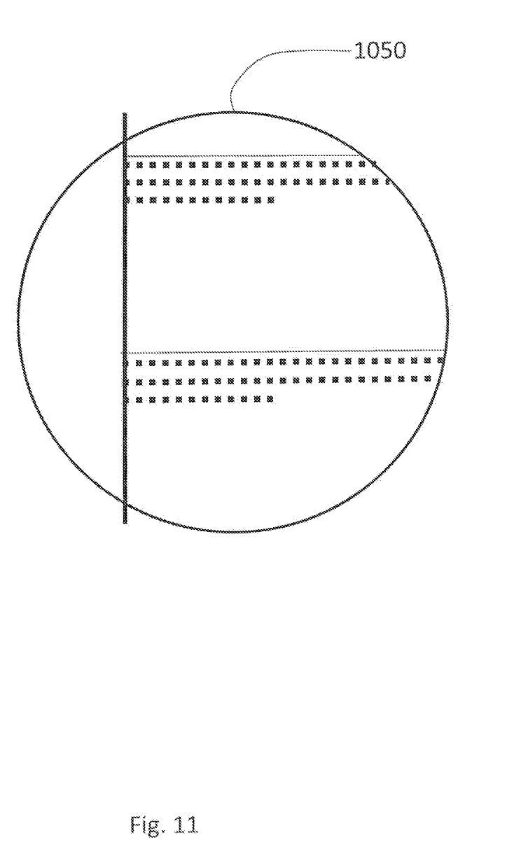

To illustrate how data is collected with an instrument like that shown in FIG. 9, consider an instrument with five identical light sources and five detectors. For simplicity, assume that one micron pixels are required in the final image, and the five light sources are spaced to provide five focus spots that are 10 microns apart on the specimen. If the miner scanner 110 and scan lens 414 provide a scan length of 1 cm in the X direction, then each detector collects data at 10,000 pixel positions for each scan of the mirror. FIG. 10 shows how the five detectors collect data for a single strip 1001 of width 1 cm on the specimen. To start the scan, the scanning stage is accelerated to a constant speed that moves the specimen 1 micron in the Y direction for each complete scan of the scanning mirror. For simplicity, assume that data is only acquired as the scanning spots move in the positive X direction, and that no data is collected during the retrace (when the spots move in the −X direction), in this example, with pixels spaced 1 micron apart in the final image, the first detector collects ten lines of data (image segment 1011) before it reaches the part of the specimen (Image segment 1012) that has already been imaged by the second detector. During this time, the third, fourth and fifth detectors have already acquired image segments 1013, 1014, and 1015. For clarity, FIG. 11 is a magnified view of area 1050 in FIG. 10, showing the left side of image segments 1011 and 1012 at the instant the scanning spots, are near the beginning of the third mirror scan in the sequence. At this instant in time, the first two lines of data are complete, and: the focus spots are moving from left to right across the specimen. Each detector acquires one pixel at-a-time as the focus spots move across the specimen.

After ten scans of the mirror, image segments 1011-1015 are complete. In this example, 10 scan lines have been acquired by each of the 5 detectors, so the scanning stage has moved 10 microns (10 scan lines). The stage is then moved an additional 40 microns and the imaging sequence is repeated, collecting image segments 1021-1025. This procedure is repeated until image strip 1001 is completed. Finally, image strips that cover the entire specimen (or the part of the specimen to be imaged) are stitched together to produce a final image of the specimen.

Increasing the number of sight source/detector pairs will increase the imaging speed of the instrument proportional to the number of light source/detector pairs, while keeping the scan speed of the focus spots constant. This is particularly important because the scan speed of confocal fluorescence instruments is slow when weak fluorophores are imaged, and the scan speed of this new instrument (with 5 source/detector pairs) is increased by a factor of 5 when compared to an instrument with only one source and one detector.

When spectrally-resolved detectors are used in a macroscope, the scan speed must be further reduced because of the reduction of light intensity falling on each detector element in the spectrometer detector array caused by spreading the beam from each focus spot over a, range of wavelengths before illuminating the detector elements in a 2D detector array in the spectrometer. For example. If 10 illumination sources are used in a linear source array, and a spectrum comprised of 16 wavelength bands is required for each spot on the specimen, then the detector array in the spectrometer will be comprised of an array of 10 rows, each containing 16 detectors, with the light from each locus spot being spread across 16 detectors in the row that detect light from that focus spot. Longer exposure times are required, and therefore slower scan speed so the increased imaging speed of this embodiment that results from using multiple light source/detector pairs is very important.

Several arrangements can be envisioned in which light sources with different frequencies are used in the detector array, with appropriate changes to the beamsplitter 610, filler 630, and detector array 750 to match these new requirements. Some of these changes have been described in the description of the third embodiment of the present invention.

We claim:

1. An instrument for scanning a large specimen supported, the instrument comprising a plurality of illumination sources, at least one lens to focus light from each illumination source on a different focus spot of the specimen simultaneously, there being a plurality of focus spots, with each illumination source being focused on a different focus spot of the plurality of focus spots, there being a plurality of spectrally resolved detectors to receive fluorescence emitted from the different focus spots simultaneously, the detectors being isolated from one another so that substantially all of the fluorescence emitted from each focus spot is received by a different detector of the plurality of detectors.

2. An instrument as claimed in claim 1 wherein the illumination sources have different wavelengths from one another.

3. An instrument as claimed in claim 1 wherein the illumination sources have substantially the same wavelength.

4. An instrument as claimed in claim 1 wherein the different focus spots on the specimen are located apart from one another by a sufficient distance to substantially eliminate crosstalk.

5. An instrument as claimed in claim 1 wherein the plurality of illumination sources are arranged to illuminate the different focus spots in a line.

6. An instrument as claimed in claim 1 wherein the plurality of illumination sources are arranged in a line and are comprised of one of a line of lasers, a line of LEO's and a line or pinholes illuminated from behind.

7. An instrument as claimed in claim 1 wherein a spectrometer containing two dimensional array detectors is used with a line of illumination sources to provide spectrally-resolved detection of each illumination source.

8. An instrument as claimed in claim 1 wherein a spectrometer containing a two dimensional array detector is used with a line of illumination sources to provide spectrally-resolved detection of each illumination source wherein the detectors are arranged so that each row in the two dimensional array detector receives light substantially from one illumination source only.

9. An instrument as claimed in claim 1 wherein there are a plurality of quantum dots on the specimen, the multiple illumination sources being arranged in a line, a spectrum from each illuminated spot on the specimen being detected using a spectrometer with multiple spectrally-resolved detectors.

10. An instrument as claimed in claim 1 wherein the instrument has a linear array of discrete illumination sources of the plurality of illumination sources located on an illumination arm and a linear array of discrete detectors located on a detection arm.

11. A method of using an instrument for scanning a large specimen, the instrument having a plurality of illumination sources, at least one lens to focus light from each illumination source on a different focus spot of the specimen, the instrument having one detector for each focus spot of the specimen that is to be detected, there being a plurality of focus spots, the method comprising activating the instrument including the plurality of illumination sources, adjusting the at least one lens to focus the light from each illumination source onto different focus spots of the specimen, each focus spot receiving light from only one illumination source, choosing and arranging spectrally resolved detectors to receive fluorescence emitted from the different focus spots simultaneously and isolating the detectors from one another so that each detector receives light substantially from one illumination source only.

12. A method as claimed in claim 11 wherein the focused spots excite fluorescence, the method including the step of detecting at least two fluorophores simultaneously with substantially reduced cross talk between the fluorophores.

13. A method as claimed in claim 11 including the step of using an illumination sources having different wavelengths from one another.

14. A method as claimed in claim 11 including the step of using illumination sources having substantially the same wavelength.

15. A method of using an instrument for scanning a large specimen, the instrument having a plurality of illumination sources, at least one lens to focus light from each illumination source to a different focus spot of the specimen, the instrument having one detector for each focus spot of the specimen that is to be detected, there being a plurality of focus spots, the method comprising activating the instrument including the plurality of illumination sources, adjusting the at least one lens to focus the light from each illumination source onto different focus spots of the specimen, each focus spot receiving light from only one illumination source, minimizing cross talk between the detectors by ensuring that the different focus spots on which the light, from the illumination source is focused are separated by distances of at least approximately ten spot diameters from each other, arranging the detectors to receive emitted or reflected light from the different focus spots simultaneously and isolating the detectors from one another so that each detector receives light substantially from one illumination source only.

16. A method of using an instrument for scanning a large specimen, the instrument having a plurality of illumination sources, at least one lens to focus light from each illumination source on a different focus spot of the specimen, the instrument having one detector for each focus spot of the specimen, that is to be detected, there being a plurality of focus spots and a plurality of detectors, the method comprising positioning the illumination sources in an XY plane such that the focus spots to be detected are along a line in the Y direction and scanning spots move across the specimen in the X direction so that the focus spots to be detected are located a distance apart, from one another to avoid any long lifetime fluorophores that are excited by a first focus spot and are detected by a second detector mixed with a fluorescence signal excited by a second illumination source, there being at least two focus spots, at least two detectors and at least two illumination sources.

17. A method as claimed in claim 15 including the steps of predicting an exposure required for each fluorophore using a high-speed preview scan and using the information from the preview scan to adjust the gain of each of the detectors for simultaneous detection of weak and strong fluorophores and the ability to scan very large specimens.

18. A method of using an instrument as claimed in claim 15 where the instrument is a combination of two instruments sharing a scanning area, scan lens and moving specimen holder, selecting any two or more of the instruments from the group of a confocal scanning fluorescence macroscope, spectrally-resolved confocal scanning fluorescence macroscope, confocal scanning reflection macroscope, scanning laser multiphoton fluorescence macroscope or harmonic detection macroscope, scanning photo luminescence macroscope, scanning brightfield macroscope using a white light source with a transmission RGB detector placed below the specimen and a scanning Raman macroscope.

19. A method as claimed in claim 16 including the steps of applying the method to confocal scanning light microscopes and microscopy.

20. A method as claimed in claim 15 where there is at least a first illumination source and a second illumination source, the method including the steps of passing the light from the first illumination source through a small-diameter fibre optic cable attached to a holder for the cable that holds an end of a fibre on a focal plane of the at least one lens.

21. A method as claimed in claim 15 including the steps of using the spectrally resolved detectors in a macroscope, reducing a scan speed significantly because a light intensity falling on each detector element is considerably reduced by spreading a beam of the light entering the detector over a range of wavelengths, allowing for longer exposure times at slower scan speed.

22. A method as claimed in claim 15 including the steps of using a confocal scanning-beam/scanning-stage optical macroscope with a single illumination arm transmitting light from an array of the illumination sources, arranging the illumination sources along a line parallel to a Y direction and a plurality of detectors being located in a single detection arm and being arranged along a line parallel to the Y direction.

23. A method as claimed in claim 15 where the instrument is a macroscope and the method includes the steps of using a linear array of light sources coupled to an area array detector and a spectrometer, for spectrally resolved detection.
